(19) United States
(12) Patent Application Publication
(10) Pub. No.: US 2025/0198830 A1
(43) Pub. Date: Jun. 19, 2025

(54) WEIGHBRIDGE

(71) Applicant: Illinois Tool Works Inc., Glenview, IL (US)

(72) Inventor: Nicholas James SALMONS, Essex (GB)

(21) Appl. No.: 18/979,154

(22) Filed: Dec. 12, 2024

(30) Foreign Application Priority Data
Dec. 14, 2023 (GB) 2319166.1

(51) Int. Cl. G01G 21/23; G01G 19/02

(52) U.S. Cl. CPC G01G 21/23; G01G 19/021

(57) ABSTRACT

The disclosure relates to a weighbridge having a deck, a load cell (20) and a load transfer assembly (10). The load transfer assembly (10) is configured to transfer displacement of the deck to the load cell (20), in use, and includes a base (30) for attachment to a static substrate, wherein the base (30) has a protrusion (40) extending therefrom. The load transfer assembly (10) also includes a bracket (50) attached to the deck and configured to move with it, wherein the bracket (50) has a first part (52) for engagement with the load cell (20) and a second part (54) having an opening (56) in receipt of the protrusion (40). The opening (56) and protrusion (40) are together configured to restrict displacement of the deck relative to the base (30), in use.

### RELATED APPLICATIONS

This application claims priority to GB Application No. 2319166.1 having an International filing date of Dec. 14, 2023, which is incorporated herein by reference in its entirety.

### TECHNICAL FIELD

This disclosure relates generally to a weighbridge, and more specifically to a weighbridge that utilizes a load cell. This disclosure also relates to a load transfer assembly for a weighbridge and a kit of parts. The disclosure further relates to a method of installing a load transfer assembly within a weighbridge.

Weighbridges, otherwise known as truck scales or railroad scales, are scales used to weigh rail or road vehicles and their contents. This can help ensure vehicles comply with the law whilst transporting goods and/or can allow companies to determine the weight of the contents of vehicles to ensure that customers are charged correctly. Weighbridges are often permanent installations, mounted on a concrete foundation.

The accuracy and reliability of weighbridges is of paramount importance, and there are a number of different ways of determining the weight of the load on a weighbridge. One such way is through the use of shear pins having strain gauges mounted on an outer surface thereof. As a load is applied to the weighbridge, the shear pins are deformed and the amount of deformation can be picked up by the strain gauges, the signals from which can be converted to a load. Due to the nature of their installation, shear pins also prevent displacement of the weighbridge deck relative to its foundation as a vehicle travels over it.

However, it has also become known to use compression load cells instead of shear pins to determine the weight of the load on a weighbridge. Unlike shear pins, due to the nature of their installation, it has been found that compression load cells fail to provide rigidity to the weighbridge and a separate anchor or stop must be installed under the weighbridge in order to prevent displacement of the weighbridge deck as a vehicle travels over it. This separate component results in additional cost of manufacture, and additional time for installation of the weighbridge.

It is therefore a first non-exclusive object of the disclosure to provide a weighbridge having a load cell that overcomes one or more disadvantages of known weighbridges.

### SUMMARY

Accordingly, an aspect of the disclosure provides weighbridge comprising: a deck; a load cell; and a load transfer assembly configured to transfer displacement of the deck to the load cell, in use; wherein the load transfer assembly comprises: a base for attachment to a static substrate, the base having a protrusion extending therefrom; the load transfer assembly further comprising a bracket attached to the deck and configured to move therewith, wherein the bracket comprises a first part for engagement with the load cell and a second part comprising an opening in receipt of the protrusion; wherein the opening and protrusion are together configured to restrict displacement of the deck relative to the base, in use.

Advantageously, the load transfer assembly enables the weighbridge to be used with a load cell whilst also restricting displacement of the weighbridge relative to its foundation without the need for a separate anchor or stop. The load transfer assembly is more compact than prior art arrangements, wherein a separate anchor or stop must be installed separately from the load cell, and can be installed more quickly.

The protrusion may be generally rectangular or square when viewed in plan. Advantageously, this may prevent rotation of the bracket relative to the base and/or protrusion, in use.

The protrusion may be any suitable polygonal shape when viewed in plan.

In some embodiments, the protrusion is circular or elliptical when viewed in plan.

The opening may correspond to or with the protrusion. The opening may be rectangular or square when viewed in plan.

The opening may be of the same shape as the protrusion when viewed in plan.

The opening may be larger than the protrusion. The opening may be the same shape and larger than the protrusion. The load transfer assembly may comprise one or more packers or shims, e.g. between the opening and the protrusion.

The protrusion may extend generally perpendicular from or to the base.

The base may be or may comprise a flat plate.

The weighbridge or load transfer assembly may comprise one or more fixings for securing or attaching the base to the static substrate.

The fixings may comprise one or more bolts or screws.

The base may comprise one or more apertures for receipt of the fixing means.

The protrusion and opening may be configured to restrict lateral displacement of the deck relative to the base, e.g. in use.

The protrusion and opening may act together or operate together to restrict lateral displacement of the deck relative to the base, e.g. in use.

The protrusion and opening may be configured to guide or facilitate displacement of the weighbridge or deck in a direction generally perpendicular to the base, e.g. in use.

The protrusion and opening may be configured to guide or facilitate displacement of the bracket in a direction generally perpendicular to the base, or along the protrusion, e.g. in use.

The protrusion and opening may together define a stop or an anchor.

The first and second parts of the bracket may be parallel to and offset from one another.

The first and second parts of the bracket may be unitary.

The bracket may comprise a U-channel section. The second part may form the base of the U-channel section and the first part may extend from the U-channel section. The first part may be connected or attached to the U-channel section.

The load cell may be received between the base and the first part of the bracket.

The load transfer assembly may comprise a load cell mounting plate.

The load cell may be received between the load cell mounting plate and the first part of the bracket.

The load cell mounting plate may be mounted, e.g. removably, to the base.

The load cell mounting plate may comprise an adjustment means to facilitate adjustment, e.g. relative to the base.

The load cell mounting plate may be adjustable toward and/or away from the base.

The load cell mounting plate may be adjustable across, e.g. laterally across, the base.

The adjustment means may comprise one or more screws received within corresponding apertures in the load cell mounting plate.

The adjustment means may comprise a two nuts on each screw, wherein each nut is located on a respective side of the load cell mounting plate.

The adjustment means may comprise a screw adjuster.

The load cell mounting plate may comprise a seat or recess for receipt of an end of the load cell.

The load cell may comprise a compression load cell.

The load transfer assembly may be received below the deck or within a service opening of the deck or weighbridge.

The bracket may be welded to the deck.

The bracket may be attached to the deck by adhesive.

The base and/or bracket may be formed of steel.

The static substrate may be or may comprise the ground or a foundation of the weighbridge.

Another aspect of the disclosure provides a load transfer assembly for a weighbridge, the assembly comprising: a base for attachment to a static substrate, the base having a protrusion extending therefrom; and a bracket arranged to be attached to a deck of a weighbridge, and configured to move therewith, in use, wherein the bracket comprises a first part for engagement with a load cell and a second part comprising an opening arranged to receive the protrusion; wherein the opening and protrusion are together configured to restrict displacement of the deck of a weighbridge relative to the base, in use.

The load transfer assembly may comprise a load cell, e.g. a compression load cell.

The static substrate may be or may comprise the ground or a foundation of a weighbridge.

Another aspect of the disclosure provides a kit of parts comprising a base and a bracket as described above.

The kit of parts may comprise one or more of a load cell, a weighbridge and one or more fixings configured to attach or secure the base to the static substrate.

Another aspect of the disclosure provides a method of installing a load transfer assembly within a weighbridge, the method comprising: providing a bracket comprising a first part for engagement with the load cell and a second part comprising an opening; attaching the bracket to a deck of the weighbridge such that is configured to move therewith, in use; providing a base having a protrusion extending therefrom; inserting the protrusion into the opening of the bracket and attaching the base to a static substrate; and providing a load cell between the bracket and the base, and engaging it with the first part of the bracket.

For the avoidance of doubt, any of the features described herein apply equally to any aspect of the disclosure. For example, the load transfer assembly, kit of parts or method may comprise any one or more features of the weighbridge relevant to the load transfer assembly, kit of parts or method and/or the method may comprise any one or more features or steps relevant to one or more features of the weighbridge, kit of parts or the load transfer assembly.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the disclosure, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the disclosure will now be described by way of example only with reference to the accompanying drawings in which:

FIG. 1 is a perspective view of a load transfer assembly for a weighbridge according to an aspect of the disclosure;

FIG. 2 is a side view of the load transfer assembly of FIG. 1;

FIG. 3 is an upper perspective view of a bracket of the load transfer assembly of FIG. 1;

FIG. 4 is a lower perspective view of the bracket of FIG. 3;

FIG. 5 is a plan view of the bracket of FIGS. 3 and 4;

FIG. 6 is an upper perspective view of the load transfer assembly of FIG. 1 with the bracket removed;

FIG. 7 is a plan view of the arrangement of FIG. 6;

FIG. 8 is a detail view of the adjustment means of the load transfer assembly of FIG. 1; and

FIG. 9 is a further view of the adjustment means of FIG. 8 with other parts removed.

### DETAILED DESCRIPTION

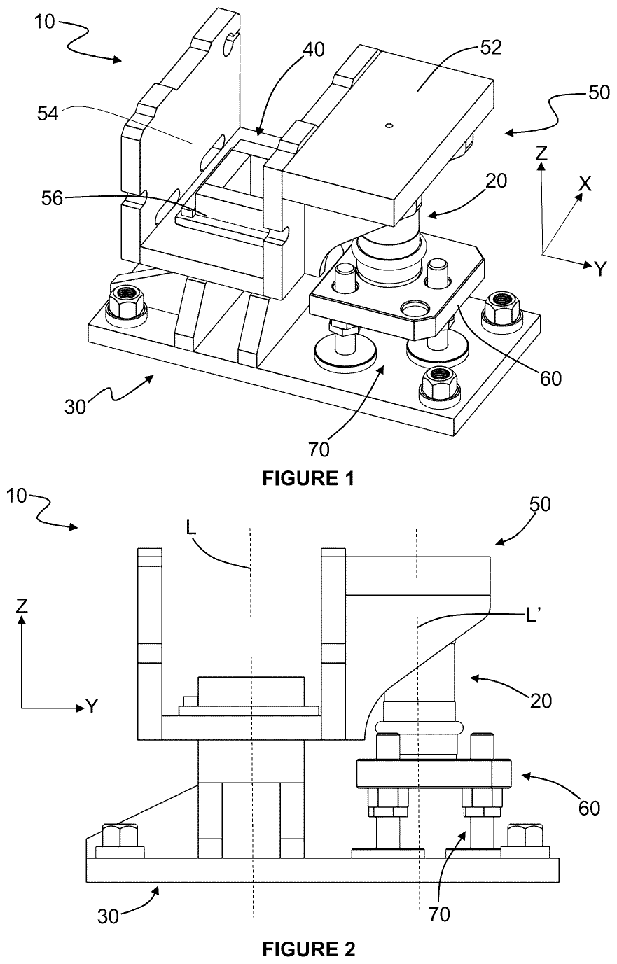

Referring now to FIGS. 1 and 2, there is shown a load transfer assembly 10 in accordance with an aspect of the disclosure for use in a weighbridge (not shown). The load transfer assembly 10 is configured to be received below the deck of a weighbridge and transfer displacement of a weighbridge to a compression load cell 20 such that the mass of a vehicle located on the weighbridge can be determined.

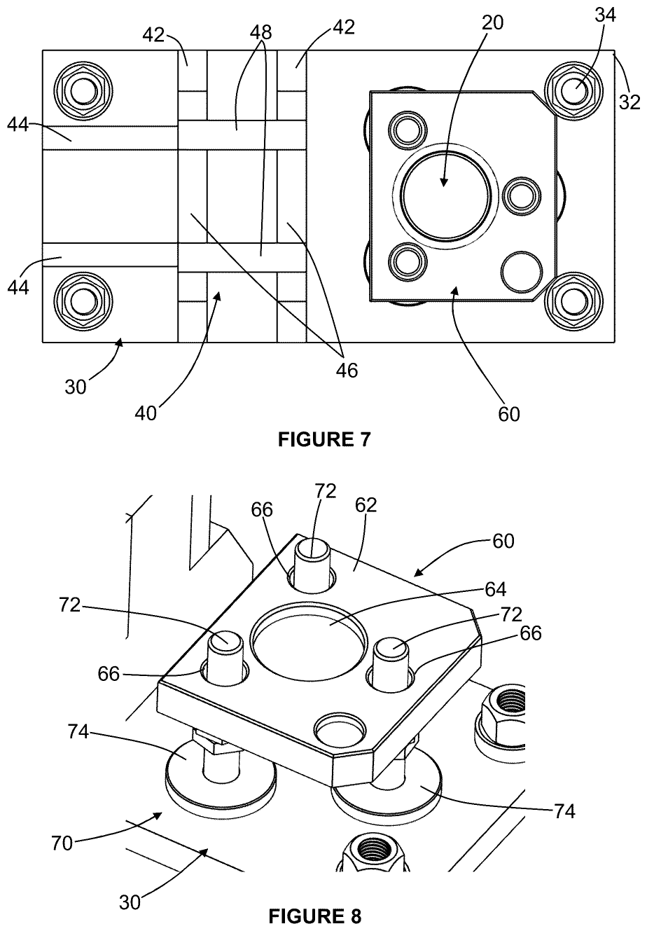

The load transfer assembly 10 includes a base 30 for attachment to a static substrate, e.g. the ground or a foundation of a weighbridge, wherein the base 30 includes a protrusion 40 extending generally perpendicular therefrom. The protrusion 40 is rectangular when viewed in plan, as shown in FIG. 7 in particular. A bracket 50 is configured to be attached to the deck of a weighbridge, e.g. by welding, so as to move as the weighbridge is displaced and has a first part 52 engaged with the load cell 20 and a second part 54 having a rectangular opening 56 in receipt of the protrusion 40. The load cell 20 is received between the first part 52 of the bracket 50 and a load cell mounting plate 60 having an adjustment means 70. The load cell mounting plate 60 is adjustable along the Z or vertical axis (hereinafter Z axis) relative to the base 30 by virtue of the adjustment means 70.

In use, the protrusion 40 and opening 56 are configured to operate together to restrict displacement of the deck of a weighbridge relative to the base 30, in use.

More specifically, the load transfer assembly 10 is arranged to facilitate displacement of the bracket 50, and therefore weighbridge deck, relative to the base 30 along the Z axis but restrict lateral displacement of the weighbridge deck in the X and Y axes relative to the base 30. It will be appreciated that the longitudinal axis L of the protrusion 40 (FIG. 2) and the longitudinal axis L′ of the compression load cell 20 each extend parallel to the Z axis.

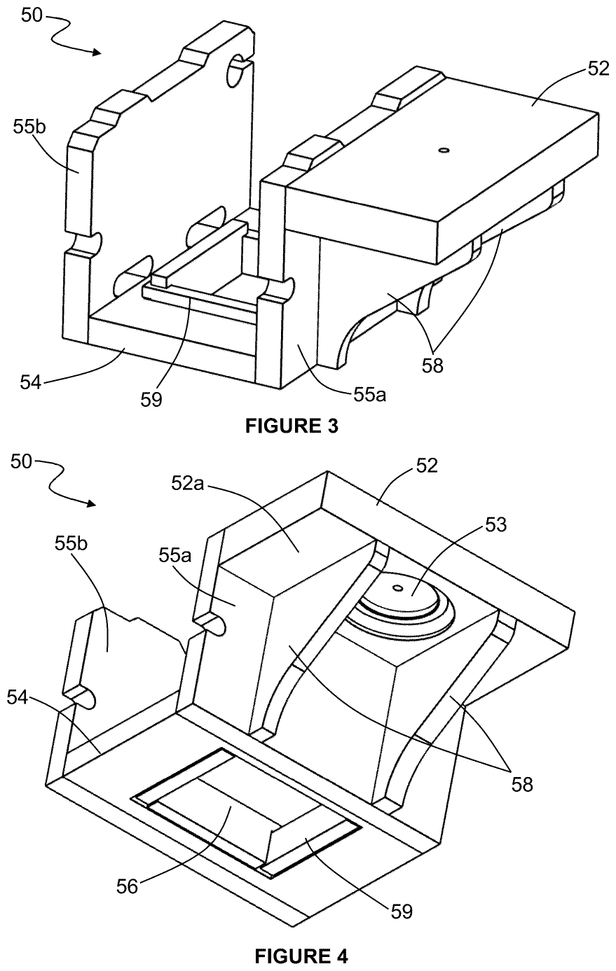

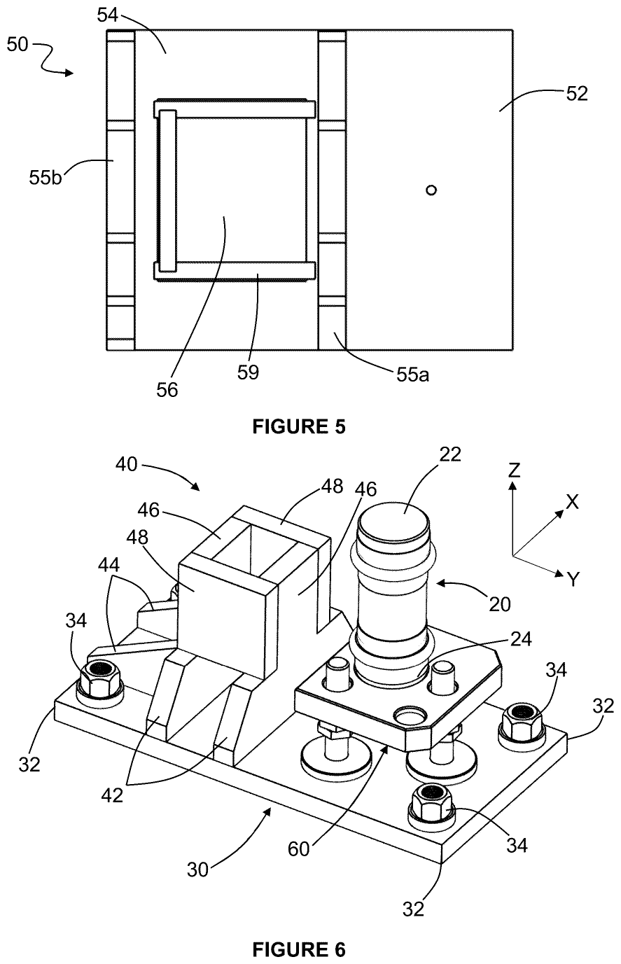

Referring now to FIGS. 3 to 5, there is shown the bracket 50 in greater detail. The first and second parts 52, 54 are parallel to and offset from one another. More specifically, the first and second parts 52, 54 are offset along the Z axis.

The first part 52 has a generally circular recess 53 in a lower surface 52a thereof. The recess 53 is configured to engage a first end 22 of the load cell 20 (FIG. 6). In the present embodiment, the first part 52 is configured to be attached to a deck of a weighbridge, in use, such that the bracket 50 moves therewith.

The second part 54 forms the flat base of a generally U-shaped section having a pair of side walls 55a, 55b located either side of the second part 54 along the Y axis. In the present embodiment, the second part 54 and side walls 55a, 55b are each provided as separate components attached to one another, e.g. by welding. The first part 52 is also provided as a separate component and extends from one of the pair of side walls 55a to a free end.

A pair of webs 58 extend between the lower surface 52a of the first part 52 and the side wall 55a so as to strengthen the connection therebetween and provide stiffness in the direction of the Z axis.

The opening 56 extends through the second part 54 and is off-centre when viewed in plan. More specifically, the opening 56 is located closer to one of the side walls 55a than the other of the side walls 55b. Furthermore, the opening 56 is larger than the protrusion 40 in this embodiment and so shims or packers 59 are provided on three sides of the opening 56 to reduced its size.

Referring now to FIGS. 6 and 7, there is shown the load cell 20, base 30 and protrusion 40 in greater detail.

The base 30 is a rectangular steel plate in this embodiment and has four apertures adjacent each of the corners 32. Each aperture is in receipt of a fixing 34, in the form of a screw in this embodiment and in which only the head and washer are shown. The fixings 34 are configured to attach the base 30 to a static substrate.

The protrusion 40 is rectangular when viewed in plan and extends generally perpendicular to the base 30. The protrusion 40 has a first pair of spaced webs 42 extending parallel to the X axis and spaced from one another along the Y axis. A second pair of spaced webs 44 extend parallel to the Y axis and are spaced from one another along the X axis. The webs 42, 44 provide stiffness to the protrusion 40 along the X and Y axes, and help prevent deformation of the protrusion 40 relative to the base 30, in use.

The protrusion 40 is formed from four components in this embodiment. First and second spaced sides 46 extend from, and are formed integrally with, the first pair of spaced webs 42. A further pair of sides 48 are provided in the form of square plate members connected across the first and second spaced sides 46.

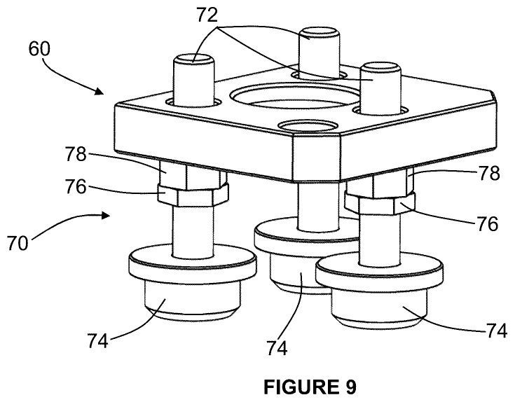

The first end 22 of the load cell 20 is shown in FIGS. 6 and 7, in the absence of the bracket 50. The second end 24 of the load cell 20 is received within a circular recess or seat 64 (FIGS. 8 and 9) of the load cell mounting plate 60, described in greater detail below in relation to FIGS. 8 and 9.

Referring now to FIGS. 8 and 9, there is shown the load cell mounting plate 60 and adjustment means 70 in greater detail. As stated above in relation to FIGS. 1 and 2, the load cell mounting plate 60 is adjustable along the Z axis relative to the base 30 by virtue of the adjustment means 70. This allows the load transfer assembly 10 to accommodate load cells 20 of different lengths. The circular recess or seat 64 is formed in an upper surface 62 of the mounting plate 60.

The mounting plate 60 is generally square when viewed in plan, and has three apertures 66 forming the apexes of a triangle. Each aperture 66 is in receipt of a respective screw 72 having a stud receiver 74 at a first end. Each screw 72 is mounted to the base 30 via its stud receiver 74, which is received within a respective aperture in the base 30. Each screw 72 has a pair of nuts 76, 78 threadedly engaged therewith and located between the mounting plate 60 and the base 30.

By providing a pair of nuts 76, 78 a locking function may be achieved, i.e. the nuts 76, 78 may not inadvertently rotate in use. In order to adjust the position of the mounting plate 60 relative to the base 30 along the Z axis, a lower nut 76 is rotated such that is it spaced from the upper nut 78. The upper nut 78 can then be rotated in either direction so as to raise or lower the mounting plate 60. The lower nut 76 can then be rotated until it abuts the upper nut 78 in order to provide the locking function.

In use, the load transfer assembly 10 is positioned below the deck of a weighbridge and the bracket 50 is secured to the deck. The protrusion 40 is received within the opening 56 in the bracket 50 and the base 30 is attached to a static substrate, e.g. the ground or a foundation of the weighbridge. The compression load cell 20 is positioned between the bracket 50 and the load cell mounting plate 60 and the necessary adjustment is made by virtue of the adjustment means 70. When a vehicle travels onto the weighbridge, in use, the deck is displaced resulting in displacement of the bracket 50. The protrusion 40 and opening 56 allow displacement of the deck along the Z axis, but restrict displacement in the X and Y directions. As the bracket 50 is displaced, the load cell 20 is compressed thereby producing an electrical output signal which can be converted to a vehicle mass by further processing.

It will be appreciated by those skilled in the art that several variations to the aforementioned embodiments are envisaged without departing from the scope of the disclosure.

It will also be appreciated by those skilled in the art that any number of combinations of the aforementioned features and/or those shown in the appended drawings provide clear advantages over the prior art and are therefore within the scope of the disclosure described herein.

1. A weighbridge comprising:
a deck;
a load cell; and
a load transfer assembly configured to transfer displacement of the deck to the load cell, in use;
wherein the load transfer assembly comprises:
a base for attachment to a static substrate, the base having a protrusion extending therefrom; and
a bracket attached to the deck and configured to move therewith, wherein the bracket comprises a first part for engagement with the load cell and a second part comprising an opening in receipt of the protrusion;
wherein the opening and protrusion are together configured to restrict displacement of the deck relative to the base, in use.

2. A weighbridge according to claim 1, wherein the protrusion is generally rectangular or square when viewed in plan.

3. A weighbridge according to claim 2, wherein the opening corresponds with the protrusion.

4. A weighbridge according to claim 1, wherein the protrusion extends generally perpendicular from the base.

5. A weighbridge according to claim 1, wherein the protrusion and opening are configured to restrict lateral displacement of the deck relative to the base, in use.

6. A weighbridge according to claim 1, wherein the protrusion and opening together define a stop.

7. A weighbridge according to claim 1, wherein the first and second parts of the bracket are parallel to and offset from one another.

8. A weighbridge according to claim 1, wherein the bracket comprises a U-channel section, the second part forms the base of the U-channel section and the first part extends from the U-channel section.

9. A weighbridge according to claim 1, wherein the load cell is received between the base and the first part of the bracket.

10. A weighbridge according to claim 1, wherein the load transfer assembly comprises a load cell mounting plate, wherein the load cell is received between the load cell mounting plate and the first part of the bracket.

11. A weighbridge according to claim 10, wherein the load cell mounting plate is mounted to the base.

12. A weighbridge according to claim 11, wherein the load cell mounting plate comprises an adjustment means to facilitate adjustment relative to the base.

13. A weighbridge according to claim 12, wherein the load cell mounting plate is adjustable toward and away from the base.

14. A weighbridge according to claim 12, wherein the adjustment means comprises one or more screws received within corresponding apertures in the load cell mounting plate.

15. A weighbridge according to claim 10, wherein the load cell mounting plate comprises a seat for receipt of an end of the load cell.

16. A weighbridge according to claim 1, wherein the load cell comprises a compression load cell.

17. A weighbridge according to claim 1, wherein the load transfer assembly is received below the deck.

18. A load transfer assembly for a weighbridge, the assembly comprising:
a base for attachment to a static substrate, the base having a protrusion extending therefrom; and
a bracket arranged to be attached to a deck of a weighbridge, and configured to move therewith, in use,
wherein the bracket comprises a first part for engagement with a load cell and a second part comprising an opening arranged to receive the protrusion;
wherein the opening and protrusion are together configured to restrict displacement of the deck of a weighbridge relative to the base, in use.

19. A load transfer assembly according to claim 18, further comprising a load cell.

20. A method of installing a load transfer assembly within a weighbridge, the method comprising:
providing a bracket comprising a first part for engagement with a load cell and a second part comprising an opening;
attaching the bracket to a deck of the weighbridge such that is configured to move therewith, in use;
providing a base having a protrusion extending therefrom;
inserting the protrusion into the opening of the bracket and attaching the base to a static substrate; and
providing a load cell between the bracket and the base, and engaging it with the first part of the bracket.
